(19) United States
(12) Patent Application Publication
(10) Pub. No.: US 2013/0229036 A1
(43) Pub. Date: Sep. 5, 2013

(54) BOOSTER SEAT CUSHION WITH REMOVABLE, WASHABLE, REVERSIBLE COVER AND ATTACHED HARNESS SYSTEM

(71) Applicants: LEO WILLARD BILL, III, JACKSON, WY (US); GRACIE MICHELLE TUCKER, JACKSON, WY (US); DANICA WINDLAND TUCKER, JACKSON, WY (US)

(72) Inventors: LEO WILLARD BILL, III, JACKSON, WY (US); GRACIE MICHELLE TUCKER, JACKSON, WY (US); DANICA WINDLAND TUCKER, JACKSON, WY (US)

(21) Appl. No.: 13/410,497

(22) Filed: Mar. 2, 2012

(51) Int. Cl. B60N 2/26

(52) U.S. Cl. CPC B60N 2/26
USPC 297/188.2; 297/219.12

(57) ABSTRACT

A booster seat cushion used on a booster seat consisting of a foam (cushioned) insert, a cover of various fabrics and a sewn in harness system that keeps the booster seat cushion attached to the booster seat and prevents it from slipping off the booster seat. The cushion can also include handle covers with accessory pockets.

### FIELD OF THE INVENTION

This invention relates to a cushion to be used on a booster seat which ensures comfort and style for kids sitting in an automobile for any length of time . . . especially longer trips when the kids buttocks becomes numb. This invention also allows the cover to be removed, easily cleaned and reversed for an all new look and secured to keep the cushion in place. The additional handle covers with accessory pockets provides further style, comfort and utility to aid the passenger in locating and storing wanted travel items, . . . pens, books, electronic toys, snacks, etc.

### SUMMARY OF THE INVENTION

Accordingly, it is an objective of the invention to provide much needed comfort, style and utility to juveniles booster seat. The booster seats are required by law, to be used in automobiles until 8 or 80 lbs, whichever comes first. The booster seats are mode of hard plastic, a fabric cover that is hard to removed and extremely uncomfortable for anyone to sit on.

Furthermore, it is intended that this booster seat cushion provide much needed and added support, comfort and shock relief of the buttocks area and spine region while being seated. This cushion pad should be described as a fancy designer cushion to dress up the ever to drab booster seat and provide relief, comfort, style and utility.

### BRIEF DESCRIPTION OF DRAWINGS

FIG. 1. This is the Side View of a typical children's booster seat (#4) with the booster seat cushion (#1) installed. The booster seat cushion fits comfortably on top of the booster seat while the webbing harness system (#2) wraps around the seat and attaches securely underneath with the webbing fastener (#3). The webbing fastener (#3) allows the two webbing ends to be pulled together to form a snug fit. (#6) is the booster seat handle.

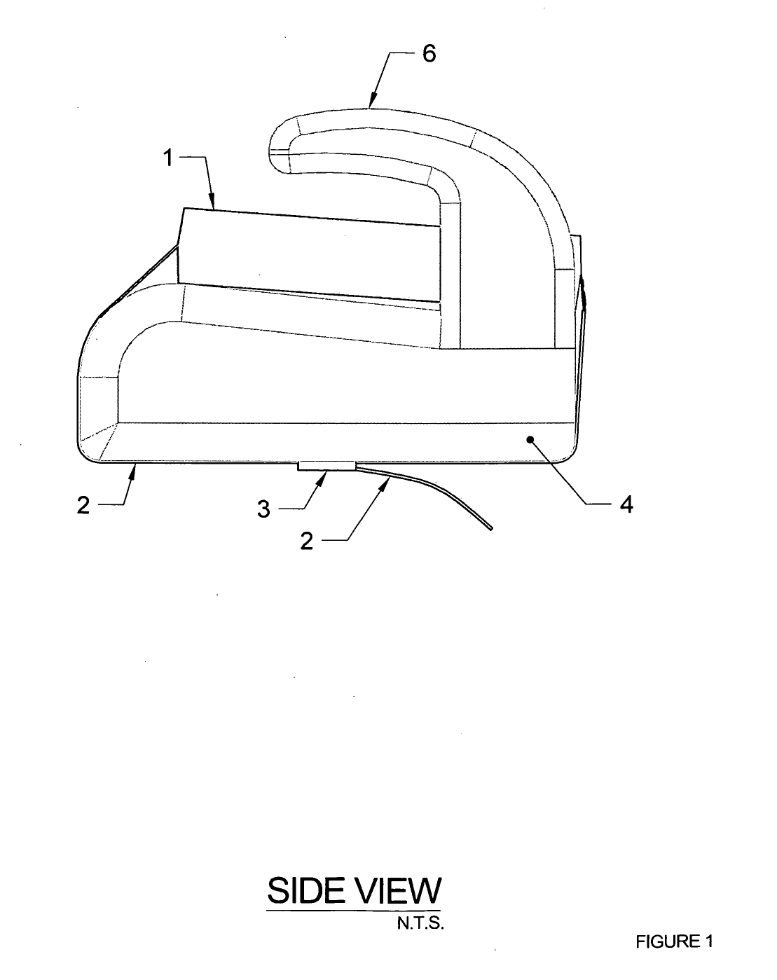

FIG. 2. This top/angled view shows the booster seat cushion (#1) off the booster seat and has the webbing harness system (#2) unattached. (#5) is the hook and loop closure sewn into the open end of the cover. (#3) is the webbing fastener. (#10) is a line of stitching that creates a pocket for the foam cushion and keeps the foam insert in place.

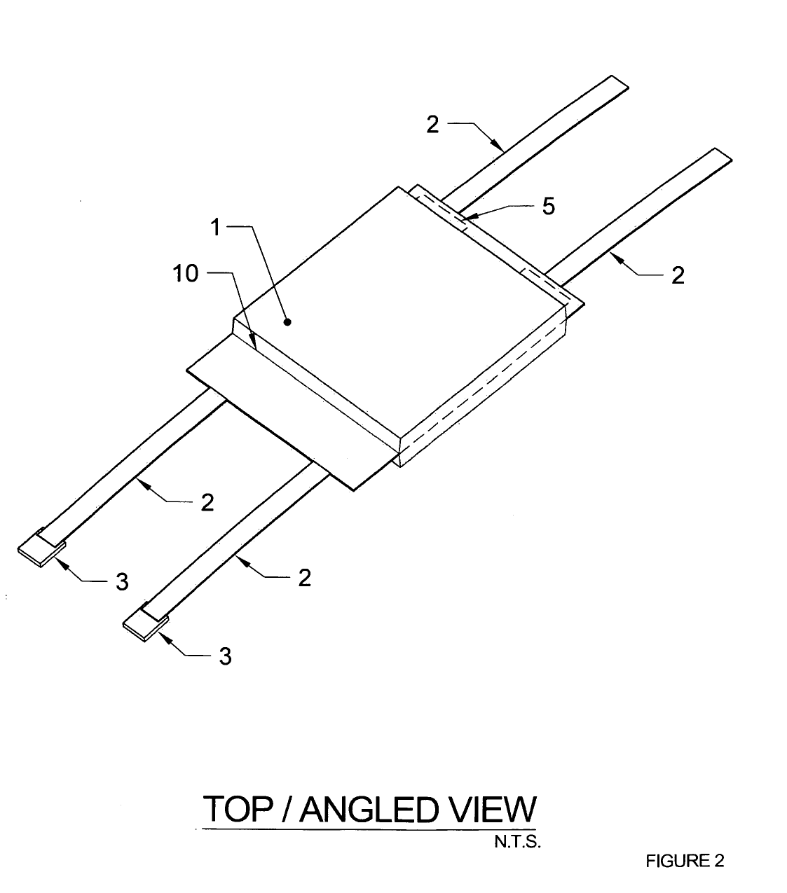

FIG. 3. This top/angled view shows the booster seat cushion (#1) off the booster seat and has the webbing harness system (#2) attached to the webbing fastener (#3). (#5) are the hook and loop closures sewn into the open end of the cover. (#10) is a line of stitching that creates a pocket for the foam and keeps the foam insert in place.

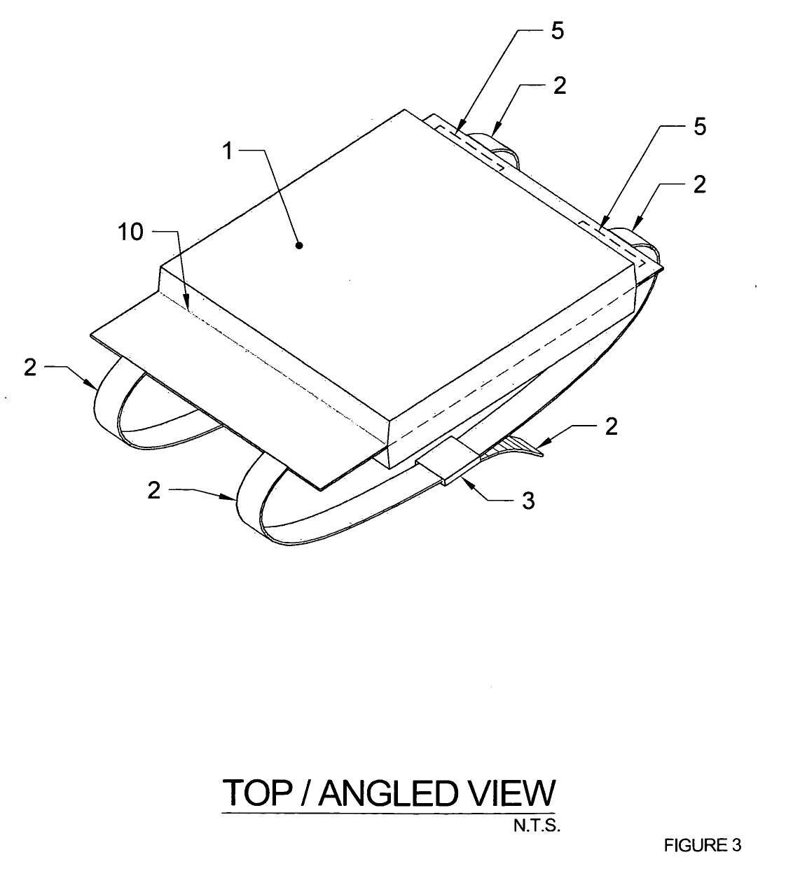

FIG. 4. This top view of a typical booster seat (#4) shows the washable, removable, reversible booster seat cushion (#1) installed with the webbing harness system (#2) attached. (#5) is the hook and loop closure on the open end of the cover. (#6) are the booster seat handles without covers. (#10) is a line of stitching that creates a pocket for the foam and keeps the foam insert in place.

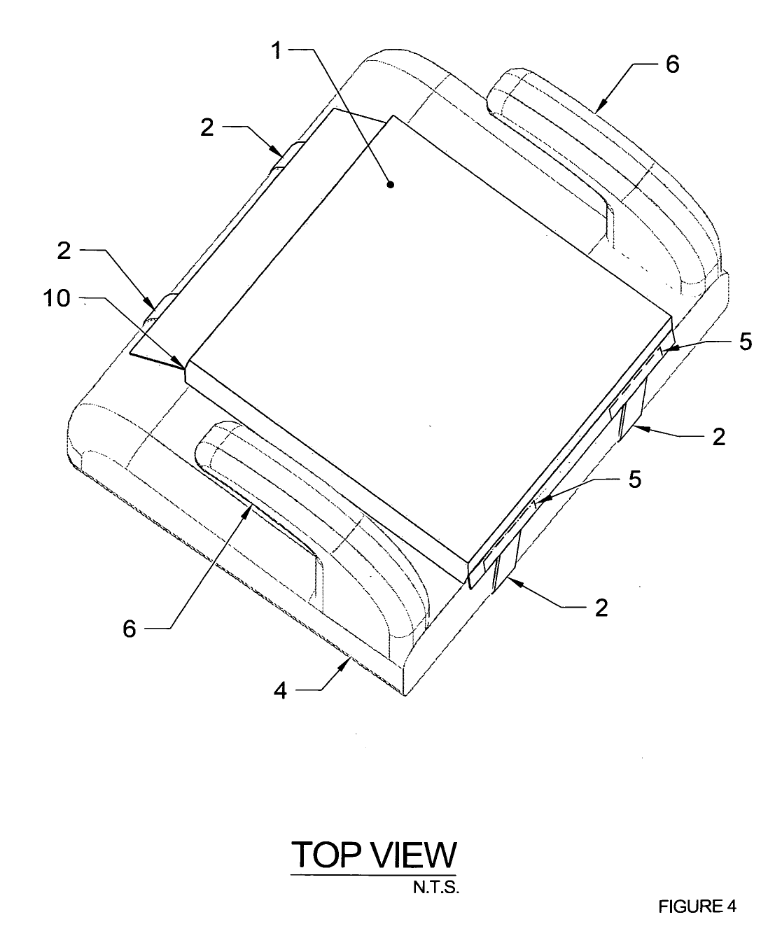

FIG. 5. This top/angled view shows a typical booster seat (#4) with the booster seat cushion (#1) and handle covers with accessory pockets (#7) installed. Hook and loop fasteners (#8) secure the handle covers to the booster seat handles. (#2) is the webbing harness system. (#5) is the hook and loop closure system which keeps the cushion inside. (#9) is a stitch a portion of the way through the handle cover which keeps the handle cover from lifting off the booster seat handle. (#10) Is a stitch across the fabric creating a pocket for the cushion while allowing extended coverage of the fabric over the booster seat.

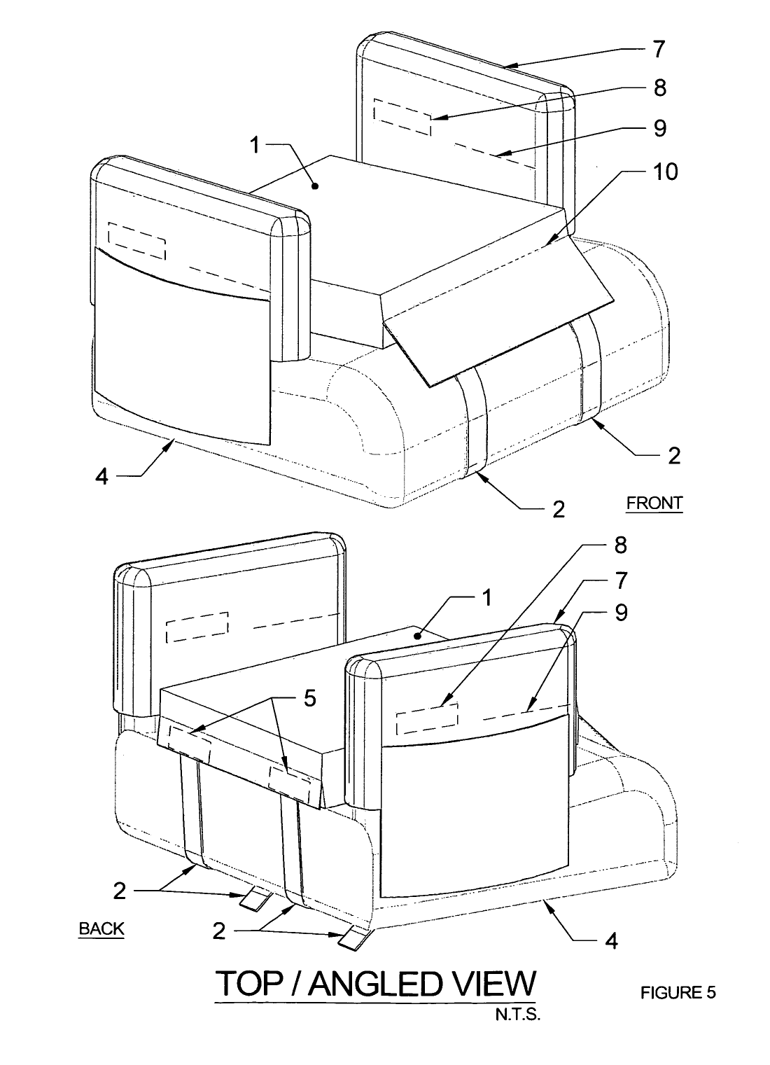

What we claim:

1. This is a child's booster seat cushion with a removable, reversible, washable cover and attached harness system to secure the cushion to the booster seat or safety seat which can also include handle covers with accessory pockets; which comprises an accessory pocket sewn forming a left and right pocket with one pocket slipping over the booster seat handle to hold the cover in place while the external pocket, with optional internal sleeves for specific items as pens, chap stick, lipstick, phones, etc., now serves the function of storing other items such as books, electronic toys, etc. and this seat cover with optional handle covers with accessory pockets consists essentially of different fabrics including polyester, cotton, bamboo, soy, neoprene, nylon, mesh or any fabric variation thereof;

2. The booster seat cushion can consist of foam, latex, rubber, wool, down, cotton, air bladder or any combination thereof and come in a variety of shapes and sizes from square, rectangle, round, wedge, triangle, zigzag or any combination thereof; this cushion comprises a cover consisting essentially of different fabrics such as polyester, cotton, bamboo, soy, neoprene, nylon, mesh or any variation thereof and is sewn on 3 sides with one side of the cover left open to insert/remove the cushion while the open side of the cover is then held closed by hook and loop, zipper, drawstring or any combination thereof.

3. The harness system consists essentially of a variety of materials including nylon, polypropylene, cotton, hemp or elastic which is comprised into straps, wraps or covers that are sewn into the seams of the seat cover at opposite sides and used to wrap around the booster seat to keep the booster seat cushion in place on top of the booster seat and secured together underneath the booster seat consisting of webbing fasteners, hook and loop, drawstring, elastic, zipper or any combination thereof and allowing the booster seat cushion to be easily removed or reversed.
